(19) United States
(12) Patent Application Publication
(10) Pub. No.: US 2025/0356764 A1
(43) Pub. Date: Nov. 20, 2025

(54) SYSTEMS AND METHODS FOR SMART TRAJECTORY PROTECTION

(71) Applicants: Airbus (S.A.S.), Blagnac Cedex (FR); Airbus Operations (S.A.S.), Toulouse (FR)

(72) Inventors: Pascal LAURENS, Toulouse (FR); Pierre BIZET, Blagnac (FR); Jonathan RIGAUD, Blagnac (FR); Sebastien SERVOLES, Blagnac (FR); Louise FAURE, Toulouse (FR); Dorothee NICOLAS, Blagnac (FR); Mathieu BRUNOT, Toulouse (FR)

(21) Appl. No.: 19/211,920

(22) Filed: May 19, 2025

Related U.S. Application Data
(60) Provisional application No. 63/649,710, filed on May 20, 2024.
(60) Provisional application No. 63/649,690, filed on May 20, 2024.

(51) Int. Cl. G08G 5/51; B64F 1/18; G08G 5/72

(52) U.S. Cl. CPC G08G 5/51; B64F 1/18; G08G 5/723

(57) ABSTRACT

An automated aircraft taxi system for an aircraft taxiing within an airport environment implements a collision-avoidance function. The collision-avoidance function triggers revision of guidance instructions and or alerts the pilots of the aircraft when a predicted trajectory of moving objects intersects a taxi path trajectory of the aircraft. The collision-avoidance function disregards an identified object that is moving on a taxiway in the airport environment when a predicted trajectory of the identified object does not intersect the taxi path trajectory of the aircraft according to the location of the identified object and the layout of taxiways on the airport map.

### CROSS-REFERENCE TO RELATED APPLICATION

This application is a non-provisional application from and claims priority to U.S. Provisional Patent Application No. 63/649,710 entitled “SYSTEMS AND METHODS FOR SMART TRAJECTORY PROTECTION”, filed on May 20, 2024, and U.S. Provisional Patent Application No. 63/649,690 entitled “AUTOMATIC AIRCRAFT TAXI SYSTEMS AND METHODS”, filed on May 20, 2024, the entire disclosures of which are incorporated by reference herein.

### TECHNICAL FIELD

The disclosure herein relates to a system for taxiing an aircraft at an airport. In particular, the disclosure herein relates to a system for predicting a trajectory of a hazard or object in a taxiway of an airport, predicting a runway incursion and taxiway incursion, and for collision avoidance between an aircraft taxiing on the taxiway and the hazard or object, preventing the runway incursion, and the taxiway incursion.

### BACKGROUND

After all of the passengers have boarded a flight and the aircraft is prepared for takeoff, the aircraft begins the taxiing phase of the flight. Similarly, after an aircraft has landed and has exited the runway, taxiing also occurs to bring the aircraft to the gate. During this phase, the aircraft travels along the ground from the gate to the runway or vice versa. Some airports are large and may have complicated taxiways. In some cases, the taxiways may include obstacles and/or hazards that taxiing aircraft need to avoid. Moreover, the airport environment may include moving objects, such as other aircrafts taxiing or airport vehicles in operation. Aircraft pilots need to monitor the obstacles and hazards present, and importantly the moving objects, to avoid risks of collisions. This increases pilots' workload when they could have many procedures to perform at the same time.

As such, there is a need for an improved system that permits to reduce pilots' workload during a taxiing process for an aircraft.

### SUMMARY

An automated taxiing system for an aircraft is disclosed comprising: a surveillance system comprising one or more sensors to capture surveillance data on a taxiway of an airport; a processing circuit in communication with the surveillance system and coupled to a memory having executable instructions stored thereon, which when executed by the processing circuit cause the processing circuit configured to: receive the surveillance data and determine, based on an analysis of the surveillance data, whether an object or hazard is present on the taxiway; in response to determining that the object or hazard is present on the taxiway, indicate a location of the object or hazard on a geographic map of the airport and save the geographic map in the memory; predict a trajectory of the object or hazard in relation to a location and trajectory of the aircraft; calculate, based on the location and trajectory of the object or hazard and the location and trajectory of the aircraft, a guidance order for the aircraft including a revised trajectory to avoid the object or hazard; and send the guidance order to an aircraft guidance system of the aircraft to thereby alter the trajectory of the aircraft to the revised trajectory.

A method for taxiing an aircraft is disclosed comprising: capturing, using a surveillance system comprising one or more sensors, surveillance data on a taxiway of an airport; receiving, at a processing circuit, the surveillance data and determining, based on an analysis of the surveillance data, whether an object or hazard is present on the taxiway; in response to determining that the object or hazard is present on the taxiway, indicating, by the processing circuit, a location of the object or hazard on a geographical map of the airport and saving the geographic map in a memory coupled to the processing circuit; calculating, by the processing circuit, a trajectory of the object or hazard in relation to a location and trajectory of the aircraft; calculating, by the processing circuit, based on the location and trajectory of the object or hazard and the location and trajectory of the aircraft, a guidance order for the aircraft including a revised trajectory to avoid the object or hazard; sending the guidance order to an aircraft guidance system of the aircraft; and altering, by the guidance system, the trajectory of the aircraft to the revised trajectory.

A non-transitory computer readable storage medium having executable instructions stored thereon is disclosed, which, when executed by a processing circuit of an aircraft system of an aircraft, causes the aircraft system to: receive surveillance data from a surveillance system comprising one or more sensors to capture the surveillance data on a taxiway of an airport; determine, based on an analysis of the surveillance data, whether an object or hazard is present on the taxiway; in response to determining that the object or hazard is present on the taxiway, indicate a location of the object or hazard on a geographic map of the airport and save the geographic map in a memory; predict a trajectory of the object or hazard in relation to a location and trajectory of the aircraft; calculate, based on the location and trajectory of the object or hazard and the location and trajectory of the aircraft, a guidance order for the aircraft including a revised trajectory to avoid the object or hazard; and send the guidance order to an aircraft guidance system of the aircraft to thereby alter the trajectory of the aircraft to the revised trajectory.

### BRIEF DESCRIPTION OF THE DRAWINGS

By way of example, specific embodiments of the disclosed methods and devices will now be described, with reference to the accompanying drawings, in which:

FIG. 1 illustrates a flow diagram in accordance with one embodiment.

FIG. 2 illustrates an example system in accordance with one embodiment.

FIG. 3 illustrates an example taxiing scenario in accordance with one embodiment.

FIG. 4 is a flow chart of an example method in accordance with one embodiment.

FIG. 5 is a logical flow diagram of an example algorithm for implementing collision-avoidance in accordance with one embodiment.

FIG. 6 is a block diagram of an example computer-readable storage medium in accordance with one embodiment.

FIG. 7 is a block diagram of an example computing system in accordance with another embodiment.

It should be understood that the drawings are not necessarily to scale and that the disclosed embodiments are sometimes illustrated diagrammatically and in partial views. In certain instances, details which are not necessary for an understanding of the disclosed methods and devices, or which render other details difficult to perceive may have been omitted. It should be further understood that this disclosure is not limited to the particular embodiments illustrated herein. In the drawings, like numbers refer to like elements throughout unless otherwise noted.

### DETAILED DESCRIPTION

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Embodiments of the present disclosure will now be described more fully hereinafter with reference to the accompanying drawings, in which several exemplary embodiments are shown. The subject matter of the present disclosure, however, may be embodied in many different forms and types of methods and devices aircraft taxiing systems, and should not be construed as limited to the embodiments set forth herein. Rather, these embodiments are provided so that this disclosure will be thorough and complete, and willfully convey the scope of the subject matter to those skilled in the art. In the drawings, like numbers refer to like elements throughout.

The systems and methods described herein provide improvements over existing systems. Namely, the integration of the surveillance functions results within a geographic map can result in benefits like lower required field of view for the surveillance sensors, or a better efficiency of the collision protection systems described herein. Additional improvements include the ability to override the protection system with dual manual inputs. The advantage here is to reduce the risk of human error when overriding the protection system.

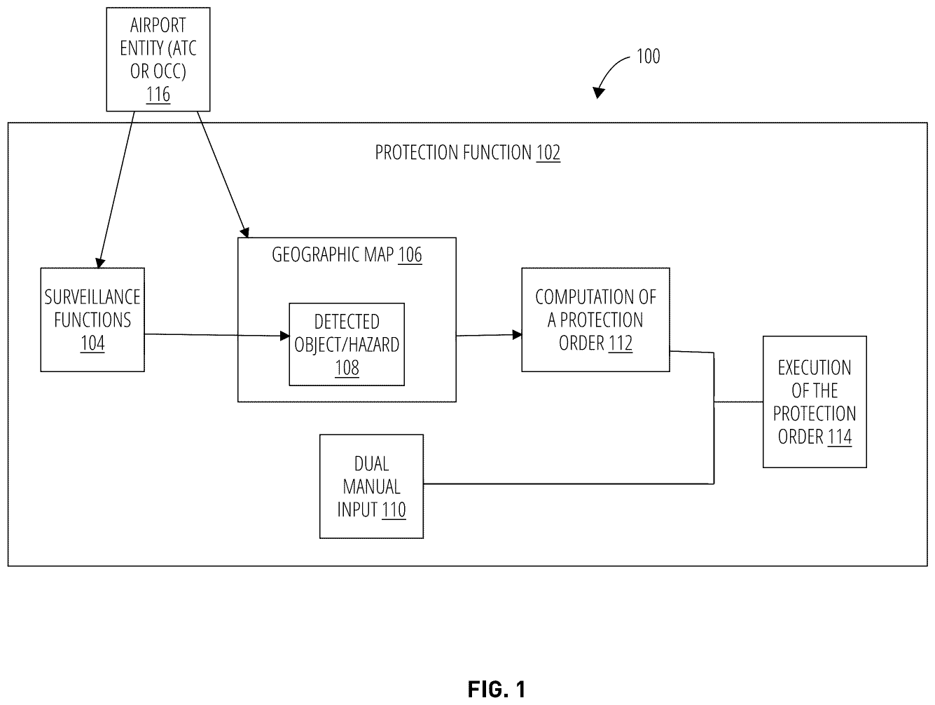

FIG. 1 illustrates a system flow 100 diagram illustrating a logical flow of an automated taxiing system for an aircraft according to example embodiments described herein. In some embodiments, the system flow 100 includes a protection function 102 for assisting an aircraft to avoid a collision with an object or hazard on the taxiway while taxiing to or from the runway. The protection function 102 begins with surveillance functions 104 capturing surveillance data on the taxiway exterior to the aircraft. Example embodiments of the surveillance functions 104 are described in more detail below. Once the surveillance functions 104 have captured the surveillance data on the objects or hazards, the surveillance data is analyzed to detect any objects or hazards on the taxiway.

Any detected object or hazard 108 is then displayed or provided on a geographic map 106 to indicate to the pilot the location of the detected object or hazard 108. The protection function 102 will then calculate or predict a trajectory of the detected object or hazard 108 and from the predicted trajectory, the protection function 102 will perform a computation of a protection order 112. The computation of the protection order involves computing a trajectory of the taxied aircraft and the detected object or hazard 108 to prevent a collision of the taxiing aircraft with the detected object or hazard 108. The protection order is then to be executed by guidance systems of the aircraft. However, before or during execution of the protection order 114, the pilot may disagree with the protection order or may want to manually override the protection order to prevent another possible issue. In this case, the protection function 102 includes a dual manual input 110 to override the protection order sent to the guidance system of the aircraft.

More specifically, the dual manual input 110 requires two manual inputs (e.g., from both pilots of the aircraft, or from one pilot of the taxiing aircraft and a second party such as an air traffic control (ATC) server or other source) to override the execution of the protection order 114. If the dual manual input 110 are entered, execution of the protection order 114 ends or does not occur (e.g., depending on when the dual manual input 110 is received).

Execution of the protection order 114 is active during a taxi phase of an aircraft, aiming at protecting the aircraft against a collision with other objects during the taxiing process, a taxiway excursion, or a runway incursion while no clearance has been provided from ATC. Integration of the surveillance functions results within a geographical map to keep the memory over time of the detected objects or characteristics to improve the performance of the surveillance function, as the aircraft is moving. One example may include as a moving object is detected by the anti-collision surveillance function, it is positioned on the airport map, so that its possible subsequent movements can be forecasted, according to the taxiway map, as the moving objects can only move on the taxiway segments or specific service roads. Another example may include as the aircraft is moving, the border lines of the taxiway are detected by the anti-taxiway excursion surveillance function, and the associated sensors, to get the required accuracy. As these border lines can be correlated with the border position on the airport map, the prediction of the taxiway border lines position in the future as the aircraft is moving can be computed. This prediction can be used for reducing the field of view of the sensor capturing the taxiway borderline (as anticipation is done thanks to the map). In another example, the anticipation itself can be better computed, predicting, for example, the next sharp turn.

An airport entity 116 (e.g., ATC or the OCC) can provide additional surveillance functions 104 and the geographic map 106 can be obtained therefrom (e.g., from an ATC server or OCC server or database). Additionally, at least part of the dual manual input 110 can be provided by the airport entity 116.

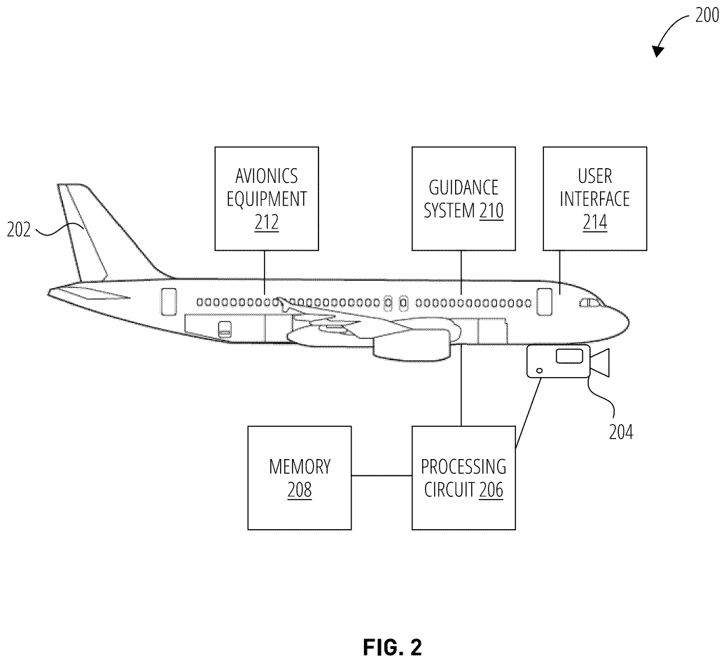

FIG. 2 illustrates an example automated taxiing system 200. In some embodiments, the automated taxiing system 200 is located within or integrated within an aircraft 202. In other embodiments the automated taxiing system 200 is embodied separate from the aircraft 202 and configured to send instructions to a guidance system 210 of the aircraft 202 to perform the maneuvers discussed herein. The automated taxiing system 200 is configured to help prevent a collision between the aircraft 202 and an object or hazard on the taxiway while the aircraft 202 is being taxied to or from the runway. The automated taxiing system 200 described herein is also to help prevent a taxiway excursion or a runway incursion while no clearance has been provided from the ATC.

The aircraft 202 comprises avionics equipment 212, which provides computing ability to the aircraft 202. The aircraft 202 comprises one or more user interfaces (e.g., a cockpit computer with a graphical user interface (GUI), screen, monitor, or other input or output device) enabling devices in the cockpit in conjunction with the avionics equipment, such as displays or touch screens or EFB (Electronic Flight Bag) device, thus enabling interactions with the pilots of the aircraft 202.

The aircraft's avionics equipment 212 includes position-awareness equipment or circuits enabling the avionics to know in real-time the geographical position of the aircraft 202, such as a GNSS (Global Navigation Satellite System) receiver, for example a GPS (Global Positioning System) receiver, a GLONASS receiver, a Galileo receiver, or other suitable device now know or later discovered.

The aircraft's 202 avionics equipment 212 preferably further includes at least one communication interface configured to enable communications through a network with Air Traffic Control (ATC) equipment of the airport's control tower (e.g., an ATC server) and further with Operations Control Center (OCC) equipment of an airline (e.g., an OCC server) with which the aircraft 202 is associated. For example, in some embodiments, the network is a mobile communications network such as 3G, long term evolution (LTE), 4G, 5G, 6G, or any other suitable mobile communications network. The network can further include a satellite-based communications network or a wired network for when the aircraft 202 is on the ground at an airport's gate, and preparing for takeoff (e.g., boarding or refueling). In some embodiments, the network includes a wireless fidelity (Wi-Fi) network or Wireless Local Area Network (WLAN), for example, when the aircraft 202 is on the ground and is in close proximity to a Wireless Access Points (WAP).

In some embodiments, the aircraft 202 embeds aspects of the automated taxiing system 200 within equipment of the aircraft, for example as part of the aircraft's guidance system 210, which is configured to implement, potentially among other functions, a collision-avoidance function, as disclosed hereafter.

In some embodiments, the automated taxiing system 200 includes a surveillance system 204 comprising one or more sensors to capture surveillance data on a taxiway of an airport. In some embodiments, the one or more sensors include one or more of: one or more cameras, a lidar device, a radar device, a microwave sensor, or an infrared sensor. The one or more sensors are configured to capture location data regarding one or more objects or hazards on the taxiway of the airport where the aircraft 202 is located. The one or more objects or hazards can include any physical hazard on the taxiway (e.g., cracks, potholes, sink hole, severe damage, etc.) or another moving or stationary object (e.g., another taxiing aircraft, parked aircraft, vehicle, tram, bus, car, light pole, mobile stairway, building, etc.) on or adjacent to the taxiway. The surveillance system 204 is further configured to capture data regarding boundaries of the taxiway, including a boundary at the gates, a boundary that leads off a taxiway segment (e.g., into a ditch or grassy path), or a boundary that ends at the runway.

In some embodiments, the automated taxiing system 200 includes a processing circuit 206 in communication with the surveillance system and coupled to a memory 208 having executable instructions stored thereon. The processing circuit 206 can be any suitable processing circuit such as a central processing unit (CPU), multi-core processor, microprocessor, an application specific integrated circuit (ASIC), or any other suitable processing circuit. Furthermore, the processing circuit 206 can be a separate system from the aircraft controls or can include a computer already onboard the aircraft but programmed to perform functions described herein. For example, the aircraft guidance system or any other suitable processing circuit 206 inside the aircraft 202 can be utilized. Alternatively, a processing circuit 206 separate from the other aircraft control systems can be used, for example a server, personal computer, or any other suitable processing circuit 206 can be used.

When the executable instructions are executed by the processing circuit 206, it is configured to perform various operations described here. For example, in some embodiments, the processing circuit 206 is configured to receive the surveillance data from the surveillance system 204. The surveillance system 204 can send the surveillance data to the processing circuit 206, for example, live or in real-time. As the processing circuit 206 receives the surveillance data from the surveillance system 204, the processing circuit 206 is configured to analyze the surveillance data and determine whether an object or hazard is present on, or adjacent to, the taxiway. In some embodiments, determining that the object or hazard is adjacent to the taxiway includes determining that the object or hazard is within a predefined or predetermined distance of the taxiway. The processing circuit 206 can determine whether the object or hazard is present on the taxiway or adjacent thereto using any suitable means. For example, the memory can further have an algorithm stored thereon that allows the processing circuit 206 being configured to determine that the hazard or objects is present on the taxiway based on known location of the taxiway and known objects on the taxiway (e.g., a map of known objects and hazards and their locations) and a known location of the aircraft as it is taxiing.

For example, the processing circuit 206 may have access to a map of the airport, including locations of objects and hazards already known, and the processing circuit 206 can determine the location of the aircraft 202 on the map (e.g., using a global positioning system or any other suitable location determination device) and its proximity to the hazards and objects on the map. From there, the processing circuit 206 can compare this known data to the data received from the surveillance system 204 and determine that current surveillance data from the surveillance system 204 is indicating known hazards and other objects (e.g., light poles, known potholes that are indicated on the map, buildings, structures, etc.).

Alternatively, the surveillance data from the surveillance system 204 can also detect unknown hazards and objects on the taxiway. For example, moving and stationary aircraft, vehicles, buses, trams, etc., can be moving or stationary on the taxiway and the surveillance system 204 can detect the unknown hazards and objects. The processing circuit 206 can determine that a hazard or object is present based on the received surveillance data, including radar signatures, lidar signatures, photographs, images, video, or other signatures indicating a solid object moving or stationary on the taxiway. The processing circuit 206 can use any suitable algorithm to detect a presence of an object or hazard on the taxiway.

In some embodiments, in response to determining that the object or hazard is present on, or adjacent to, the taxiway, the processing circuit 206 is further configured to indicate a location of the object or hazard on a geographic map of the airport and save the geographic map or the location of the object or hazard in the memory 208. In some cases, the geographic map or location of the object or hazard can be saved and shared with a network of computers that other aircraft have access to the geographic map with hazards and objects indicated thereon. In some embodiments, the processing circuit 206 can indicate the location of the object or hazard on the geographic map of the airport by first determining its own location on the map and then, based on measurements from the surveillance system 204, the processing circuit 206 can determine a distance and direction of the hazards and objects from the current location of the aircraft 202. Once these determinations are made, the processing circuit 206 can determine on the map where the hazards and objects should be indicated based on the distance and direction of an identified hazard or object.

Additionally, in some embodiments, the processing circuit 206 is further configured to predict a trajectory of the object or hazard in relation to a location and trajectory of the aircraft 202. For example, in some embodiments, the surveillance system 204 can determine that the object or hazard is stationary based on the surveillance data captured by the surveillance system 204, whereby a current speed and direction of the aircraft 202 and a change of speed and direction of the detected hazard or object can be calculated and used to determine that the object or hazard is stationary or moving. As a further example, if, as the surveillance system 204 monitors a specific hazard or object, the specific hazard or object is approaching the aircraft 202 faster than the speed of the aircraft 202, the specific hazard or object is likely moving. If, however, the surveillance system 204 detects that the specific hazard or object is moving toward the aircraft 202 at the same speed as the aircraft 202 and as the aircraft travels in the direction of the specific hazard or object, the specific hazard or object is likely a stationary one. Those having ordinary skill in the art will appreciate that any suitable motion detection and objection trajectory algorithms can be utilized to determine a trajectory and location of the object or hazard. The trajectory of the hazard or object is determined with respect to the trajectory and location of the aircraft 202 such that the processing circuit 206 determines whether the aircraft 202 is likely to collide with the hazard or object.

Predicting the trajectory of the object or hazard can be constrained somewhat by the object or hazard's position on the geographic map. For example, the object or hazard's location is provided on the geographic map of the airport and the trajectory is predicted based on various taxiway segments and borderlines. It is likely that the object or hazard will follow the taxiway segments or services roads, and therefore, the processing circuit 206 makes the prediction of the trajectory of the hazard or object with the position of the object or hazard and its relation to taxiway segments and service roads as a consideration.

As described above, in some embodiments, the object or hazard is a stationary object. In such a case, the processing circuit 206 is configured to determine that the object or hazard is a stationary object based on the surveillance data and the location of the object or hazard on the geographic map. In response to the processing circuit 206 determining that the object or hazard is a stationary object, the processing circuit 206 is configured to predict that the object or hazard will remain stationary in relation to the aircraft.

In some embodiments, the processing circuit 206 is further configured to calculate, based on the location and trajectory of the object or hazard and the location and trajectory of the aircraft 202, a guidance order for the aircraft 202 including a revised trajectory to avoid the object or hazard. The revised trajectory can include, for example, changing the direction of the trajectory of the aircraft 202, turning to avoid the object's trajectory or position, slowing the aircraft 202 down to avoid a passing object, or any other suitable maneuver to ensure that the aircraft 202 does not collide with the object or hazard. The processing circuit 206 is configured to determine whether the predicted trajectory of the hazard or object intersects with or is likely to intersect with a predicted trajectory of the aircraft 202 during the taxiing operation.

In some embodiments, the processing circuit 206 is configured to access the geographic map of the airport, wherein the geographic map includes a predefined object or hazard present on the taxiway. In this embodiment, calculating the guidance order including the revised trajectory includes the processing circuit 206 being configured to calculate the guidance order and revised trajectory to avoid the predefined object or hazard present on the taxiway. In some embodiments, accessing the geographic map includes the processing circuit being configured to communicate with an airport entity 116 to access the geographic map, wherein the airport entity includes an Air Traffic Control (ATC) computing device or an Operations Control Center (OCC) computing device.

In some embodiments, the surveillance system 204 is further configured to detect borderlines of the taxiway. Upon detection of the borderlines, the processing circuit 206 is further configured to correlate the borderlines to mapped borderlines of the taxiway on the geographic map and predict a further location of the taxiway borderlines as the aircraft continues moving, the further location of the taxiway borderlines being based on the mapped borderlines of the taxiway. In some embodiments, predicting the trajectory of the object or hazard includes the processing circuit 206 being configured to predict the trajectory of the object or hazard based on the geographic map of the taxiway. In some embodiments, predicting the trajectory of the object or hazard and calculating the guidance order are performed based on the borderlines of the taxiway correlated to the mapped borderlines of the taxiway on the geographic map.

In some embodiments, once the borderlines are mapped onto the geographic map, a field of view of the one or more sensors of the surveillance system 204 can be adjusted by the processing circuit 206 being configured to no longer capture data on the borderlines of the taxiway. In some embodiments, the borderlines might not need to be remapped. For example, a full 360° view from the sensors might now be required if hazards previously detected are stored in the memory on the geographic map.

In some embodiments, the guidance order is calculated based on the trajectory of the aircraft 202, the trajectory of the object or hazard (including, for example, a stationary object in the path of the aircraft 202), and the known boundaries (e.g., borderlines) of the taxiway. For example, the guidance order will be calculated to not only avoid the collision with the object or hazard, but also to avoid running off the taxiway (e.g., crossing the taxiway borderline into grass or building, or another object or hazard). Once the guidance order is computed or calculated, the processing circuit 206 is configured to send the guidance order to an aircraft guidance system 210 of the aircraft 202 to thereby alter the trajectory of the aircraft 202 to the revised trajectory.

In some embodiments, the pilot or co-pilot of the aircraft 202 may wish to override or cancel the execution of the revised trajectory, for example to prevent the aircraft 202 from hitting another object not seen by the surveillance system 204. In order to override the guidance system 210 executing the guidance order, a dual input override sequence is executed. For example, both pilots may provide an input to the processing circuit 206 or the guidance system 210 indicating that they wish to override the guidance order. In another embodiment, one pilot provides the override input and an ATC server (operated by an ATC controller), or an airline operational center server (operated by an airline dispatcher) provides the second input to override execution of the guidance order by the guidance system 210.

In another embodiment, the processing circuit 206 is further configured to order and thereby end alteration of the trajectory of the aircraft in response to receiving dual inputs to override the guidance order, wherein the dual inputs include inputs from any of both pilots of the aircraft; one pilot and an air traffic control (ATC) system; or one pilot and an operations control center (OCC) system. In some embodiments, the automated taxiing system 200 further comprises a user interface 214 with which pilots can interact and is configured to receive instructions from the pilots of the aircraft to request that the guidance order be overridden. In some other embodiments, the automated taxiing system is configured to receive electronic messages from the airport entity 116 (e.g., ATC system and/or the OCC system) which provide confirmation that the guidance order can be overridden. In some embodiments, the user interface 214 can include a graphic user interface (GUI) with a touchscreen, a computer system with keyboard, mouse, and other inputs, or other suitable input and/or output device (e.g., the cockpit avionics equipment 212 or other equipment inside the cockpit can be included.

In some embodiments, the pilot may attempt to voluntarily (e.g., manually) taxi the aircraft 202 onto the runway without clearance for the aircraft 202 to do so. In such a case, altering the trajectory of the aircraft 202 to the revised trajectory includes the processing circuit 206 being cased to send a control signal to braking systems of the aircraft 202 to stop the aircraft 202 and prevent the aircraft 202 from moving onto the runway. In some embodiments, the pilot may seek to override the runway incursion protection system and provide an override input to override by seeking ATC permission to enter the runway, and then the pilot can provide an input to the runway incursion protection system, and the processing circuit 206 receives that input indicating the ATC has provided permission. Alternatively, both the pilot and the co-pilot must provide the input indicating ATC has given permission. Upon receiving the input (e.g., single or dual inputs, as the case may be) the processing circuit 206 can then send a signal to the braking system to override the runway incursion protection system and allow the aircraft 202 to taxi onto the runway.

In some embodiments, altering the trajectory of the aircraft 202 to the revised trajectory includes the guidance system 210 being configured to move the aircraft 202 onto or towards a runway at the airport. However, in some cases, a runway incursion protection system onboard the aircraft 202 as part of the guidance system 210 may prevent the aircraft 202 from moving onto the runway. In such a case, the processing circuit 206 and/or guidance system 210 is further configured to receive clearance to move the aircraft 202 onto the runway from the pilot in response to an air traffic control (ATC) server communicating the clearance to the pilot. The processing circuit 206 is further configured to receive an input from the pilot and co-pilot of the aircraft or from the pilot and an airline operational center (OCC), the input overriding the runway incursion protection system and allowing the aircraft 202 to move onto the runway. In some other embodiments, the processing circuit 206 is further configured to receive only one input from the pilot or the co-pilot of the aircraft 202 or from the OCC. Only the single input may be required to override the runway incursion protection system and allow the aircraft 202 to move onto the runway.

The below description further clarifies the options for overriding the runway incursion and protection system using single or dual inputs. The example is given with the runway incursion protection. Runway incursion is authorized only after a clearance is given by the ATC to the pilots. Dual manual inputs can be used in the following ways. A first design can be considered, with the pilot able to inhibit the runway incursion protection by confirming that the ATC clearance has been received. If the runway incursion protection is activated, this means that the pilot was considering entering a runway without taking care of the clearance, which is a pilot error case. In that case, the protection stops the aircraft before entering the runway. To unlock the protection, a dual manual input is then required to cope with any error persistence. The dual input can be performed either by both pilots, or by the pilot and the ATC controller, or by the pilot and the dispatcher in the Airline Operational Center (OCC).

A second design can be considered with a systematic dual manual input required to inhibit the runway incursion protection. These inputs can be done in the same way as with the first design either by the two pilots, or by the pilot and the ATC controller, or by the pilot and the dispatcher in the Airline Operational Center (OCC)

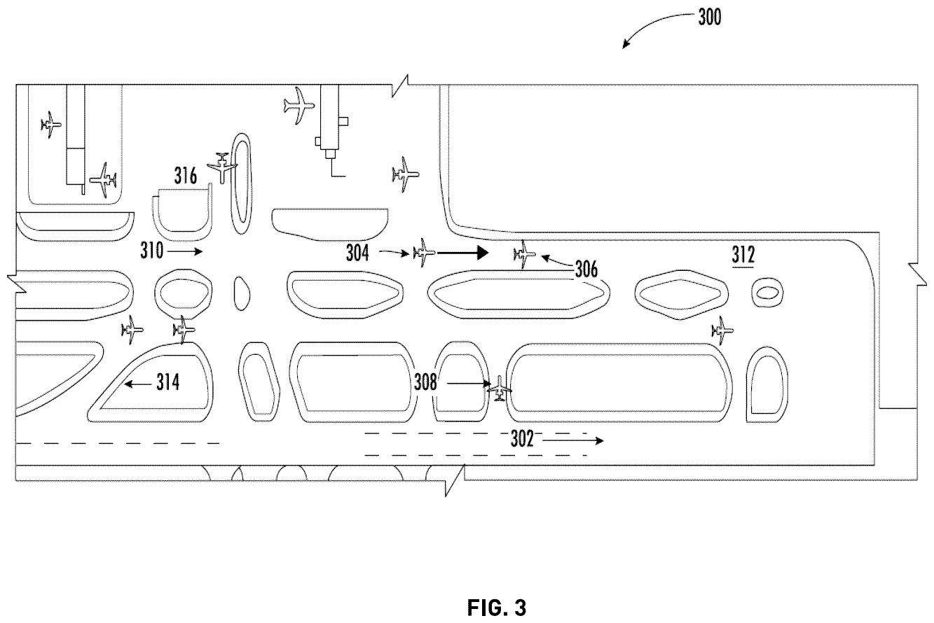

FIG. 3 is a geographic map illustrating a taxiing scenario 300 of a taxiing aircraft 304. The geographic map includes the runway 302, taxiway segments 310, service road 316 locations, and the gates for the aircraft to leave from and travel to. The geographic map further includes the locations of taxiway borderlines 314, potential hazards 312, and a first moving object 306, and a second moving object 308 (e.g., other aircraft moving along the taxiway segments 310).

In some embodiments, determining that the object (e.g., first moving object 306 or second moving object 308) or hazard (e.g., hazard 312) is present on the taxiway includes the processing circuit 206 from FIG. 2 being configured to determine whether the object or hazard is located on a taxiway segment 310 or service road 316 at the airport. In some embodiments, determining that the object or hazard is adjacent to the taxiway 310 includes the processing circuit 206 being configured to determine whether the object or hazard is located within a predetermined distance of the taxiway segment 310 or service road 316. Additionally, predicting the trajectory of the object or hazard includes the processing circuit 206 being configured to forecast or predict a movement of the object or hazard on the taxiway segment 310 or service road 316.

For example, the taxiing aircraft 304 is the aircraft 202 from FIG. 2 that includes the automated taxiing system 200 located thereon. The surveillance system 204 will detect the first moving object 306 using the one or more sensors and the processing circuit 206 will predict a trajectory of the first moving object 306 on the geographic map in relation to the taxiing aircraft 304. If the system did not take the geographic map, including the location and boundaries of the taxiway segment 310 into account when predicting the trajectory of the first moving object 306, the processing circuit 206 might (erroneously) predict that a collision will likely occur between the taxiing aircraft 304 and the first moving object 306 (e.g., depending on a speed of each aircraft). However, because the automated taxiing system 200 takes into account the above considerations, including the location and boundaries of the taxiway segments 310, it may determine or predict that the first moving object 306 will continue around the nearby curve in its path. The taxiing aircraft 304 can then be directed by the guidance order to proceed along its current trajectory, down the taxiway toward the hazard 312, so that it avoids the first moving object 306 that will go around the curve.

Also, the surveillance system 204 may detect the second moving object 308 and the processing circuit 206 will predict its trajectory. At the current trajectory of the second moving object 308 it may appear to be on a path to collide with the taxiing aircraft 304. However, because the processing circuit 206 takes into account the taxiway segments 310 and their boundaries, the processing circuit 206 will predict that, instead of going straight, the second moving object 308 will likely turn counterclockwise into the curve it is currently in and remain on the taxiway segment 310 and move off the path of collision with the taxiing aircraft 304. Because the first moving object 306 and second moving object 308 can only move along the taxiway segment 310 and other vehicles such as trams and cars can only move along the service road 316, the processing circuit 206 can better predict the trajectory of these objects and better predict a collision because the processing circuit 206 can eliminate possible routes of the objects (e.g., eliminate routes that involve the objects moving off the taxiway segment 310 and service road 316).

In another example, a hazard 312 is present on the taxiway segment 310 and this is a stationary object or hazard such as a pothole or a stopped car or structure. In this case, as the taxiing aircraft 304 approaches the hazard 312, the surveillance system 204 will detect its presence and the processing circuit 206 will predict that it will remain in place based on its current movement, which is none.

Integration of the surveillance functions results within a geographical map to keep the memory over time of the detected objects or characteristics to improve the performance of the surveillance function, as the aircraft is moving. For example, as a moving object is detected by the anti-collision surveillance function, it is positioned on the geographical map, so that its possible subsequent movements can be forecasted, according to the taxiway portion of the geographical map, as the moving objects can only move on the taxiway segments or specific service roads.

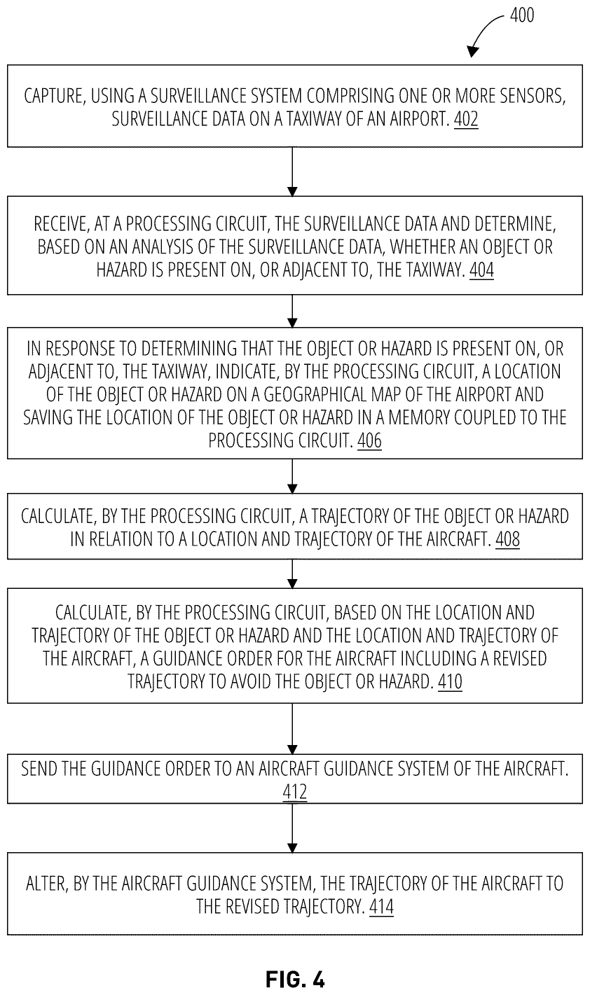

FIG. 4 is a flow chart of an example method 400 for taxiing an aircraft. In some embodiments, as shown at block 402, the method 400 includes capturing, using a surveillance system comprising one or more sensors, surveillance data on a taxiway of an airport. At block 404, the method 400 includes receiving, at a processing circuit, the surveillance data and determining, based on an thereof, whether an object or hazard is present on, or adjacent to, the taxiway. At block 406, the method 400 includes in response to determining that the object or hazard is present on, or adjacent to, the taxiway, indicating, by the processing circuit, a location of the object or hazard on a geographical map of the airport and saving the location of the object or hazard in a memory coupled to the processing circuit.

As shown at block 408, in some embodiments, the method 400 includes calculating, by the processing circuit, a trajectory of the object or hazard in relation to a location and trajectory of the aircraft. As shown at block 410, the method 400 includes calculating, by the processing circuit, based on the location and trajectory of the object or hazard and the location and trajectory of the aircraft, a guidance order for the aircraft including a revised trajectory to avoid the object or hazard. As shown at block 412, the method 400 includes sending the guidance order to an aircraft guidance system of the aircraft. As shown at block 414, the method 400 includes altering, by the aircraft guidance system, the trajectory of the aircraft to the revised trajectory.

In some embodiments, the geographic map of the airport comprises taxiway segments and service road locations. In some embodiments, determining that the object or hazard is present on the taxiway includes determining whether the object or hazard is located on a taxiway segment or service road. In some embodiments, determining that the object or hazard is adjacent to the taxiway includes determining whether the object or hazard is located within a predetermined distance of the taxiway segment or service road. In some other embodiments, predicting the trajectory of the object or hazard forecasting a movement of the object or hazard on the taxiway segment or service road.

In some embodiments, the object or hazard is a stationary object, and the method further includes determining that the object or hazard is the stationary object based on the surveillance data and the location of the object or hazard on the geographic map. In some embodiments, in response to determining that the object or hazard is a stationary object, the method further includes predicting that the object or hazard will remain stationary in relation to the aircraft.

In some embodiments, the method further includes using a surveillance system comprising one or more sensors to detect borderlines of the taxiway. In some embodiments, the method further includes correlating the borderlines to mapped borderlines of the taxiway on the geographic map and predicting a further location of the taxiway borderlines as the aircraft continues moving, the further location of the taxiway borderlines being based on the mapped borderlines of the taxiway. In some embodiments, predicting the trajectory of the object or hazard and calculating the guidance order are performed based on the borderlines of the taxiway correlated to the mapped borderlines of the taxiway on the geographic map.

In some embodiments, predicting the trajectory of the object or hazard includes predicting the trajectory of the object or hazard based on the geographic map of the taxiway. In some embodiments, altering the trajectory of the aircraft to the revised trajectory includes moving the aircraft towards a runway. In some embodiments, a runway incursion protection system prevents the aircraft from moving onto the runway by instructing the aircraft guidance system to stop the aircraft before the aircraft enters the runway.

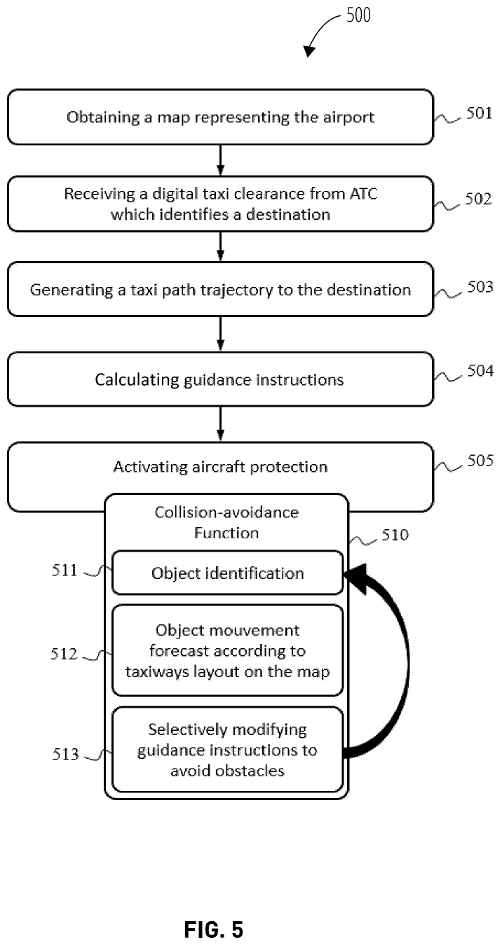

FIG. 5 illustrates a logical flow of an algorithm 500 for implementing collision-avoidance by the automated taxi system 100 in accordance with one embodiment.

As shown at block 501, the automated taxiing system 200 obtains an airport map representing the airport environment. The airport map may identify locations of objects or hazards already known within the airport environment.

As shown at block 502, the automated taxiing system 200 obtains a digital taxi clearance from the ATC equipment 116, the digital taxi clearance identifying a destination within the airport environment to which the aircraft 202 is instructed to taxi.

As shown at block 503, the automated taxiing system 200 generates a taxi path trajectory (guidance path) of the aircraft 202 to the destination on the airport map, for example as many conventional navigation systems do. The generated taxi path trajectory avoids collision of the aircraft 202 with objects or hazards already present on the airport map.

As shown at block 504, the automated taxiing system 200 computes guidance instructions based on the taxi path trajectory, so that the guidance instructions enable automatically guiding the aircraft 202 within the airport environment according to the taxi path trajectory until reaching the destination.

As shown at block 505, the automated taxiing system 200 activates aircraft protection. Then, as shown at block 510, the automated taxiing system 200 activates a collision-avoidance function. Other aircraft protection functions may also be activated, such as anti-excursion function to prevent the aircraft 202 from crossing taxiway borders and/or anti-incursion function to prevent the aircraft 202 from entering a runway while no clearance from ATC has been received beforehand.

Within the collision-avoidance function, as shown at block 511, objects are identified. In some embodiments, surveillance data from the surveillance system 204 is used to do so. In response to determining that the object or hazard is present on the taxiway, the automated taxiing system 200 indicates the location of the object or hazard on the airport map, saves the airport map in memory, and updates the airport map in real-time to show actual position of the aircraft 202 and of identified objects and hazards. The automated taxiing system 200 can display in real-time the airport map for the pilot(s) of the aircraft 202 to view the information contained in the airport map thus updated.

As shown at block 512, the automated taxiing system 200 forecasts (or predicts) objects movement (or trajectory) within the airport environment by using the layout of taxiways in the airport map, as disclosed above. The automated taxiing system 200 determines whether or not the predicted trajectory of the object in question intersects with or is likely to intersect with the taxi path trajectory of the aircraft 202.

As shown at block 513, the automated taxiing system 200 selectively modifies the guidance instructions to avoid the identified objects according to whether or not, in the case of moving objects, the predicted trajectory of the identified objects intersects with the taxi path trajectory of the aircraft 202. The guidance instructions can be modified so as to apply a revised taxi path trajectory of the aircraft 202 to the destination. As detailed hereafter, the automated taxiing system 200 may disregard some objects in the collision-avoidance function, depending on the trajectory of the object with respect to the layout of taxiways (or service roads) on the airport map and on the current taxi path trajectory of the aircraft 202. Thus, spurious triggering of alerts to the pilot(s) and/or uncomfortable actions (e.g., unexpected turn or auto-brake) are avoided.

Thus, in some embodiments, the method performed by the automated taxiing system 200 includes calculating, based on the location and trajectory of an identified object or hazard and the location and trajectory of the aircraft 202, new guidance instructions for the aircraft 202 including a revised trajectory to avoid the object or hazard. The guidance instructions are thus modified to thereby alter the taxi path trajectory of the aircraft 202 to the revised trajectory. When the taxi path trajectory of the aircraft 202 cannot be modified to avoid that the taxi path trajectory of the aircraft 202 passes through a detected object or hazard, which means that no alternative taxi path trajectory can be found, the collision-avoidance function 510 shall anyway trigger revision of the guidance instructions to avoid collision (typically engage auto-braking of the aircraft 202 so as to stop the aircraft 202) and/or alert the pilots of the aircraft.

The modified guidance instructions can thus include, for example, changing the direction of the trajectory of the aircraft 202 to get around the identified objects, turning to avoid the object's trajectory or position, slowing the aircraft 202 down to avoid a passing object by activating auto-braking function of the aircraft 202, or any other suitable maneuver to ensure that the aircraft 202 does not collide with the object or hazard.

The guidance instructions are thus recursively modified in real-time according to the update of objects identification and of the prediction of their trajectory according to the layout of the taxiways on the airport map, as well as to the potential revisions of the taxi path trajectory of the aircraft 202.

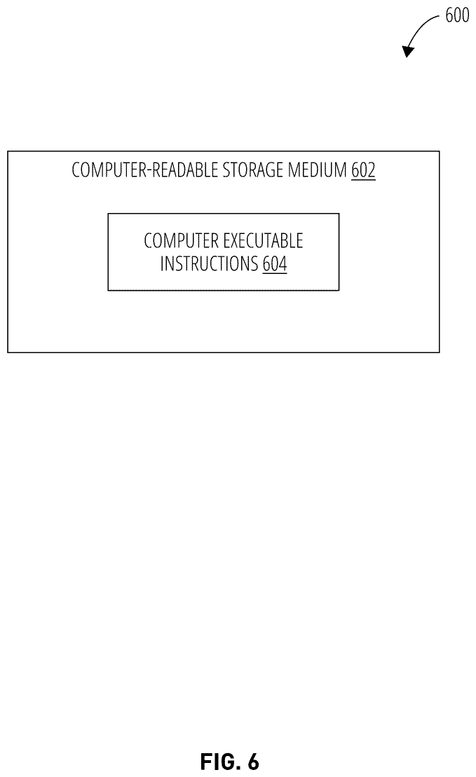

FIG. 6 illustrates an apparatus 600. Apparatus 600 comprises any non-transitory computer-readable storage medium 602 or machine-readable storage medium, such as an optical, magnetic or semiconductor storage medium. In various embodiments, apparatus 600 comprises an article of manufacture or a product. In some embodiments, the computer-readable storage medium 602 stores computer executable instructions with which one or more processing devices or processing circuitry can execute. For example, computer executable instructions 604 includes instructions to implement operations described with respect to any method, operation, logic flows, timing diagram, or embodiment described herein. The executable instructions 604 includes instructions to perform any function described above or any portion of the methods 400 or 500 described above.

Examples of computer-readable storage medium 602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 604 include any suitable type of code, such as source code, compiled code, interpreted code, executable code, static code, dynamic code, object-oriented code, visual code, and the like.

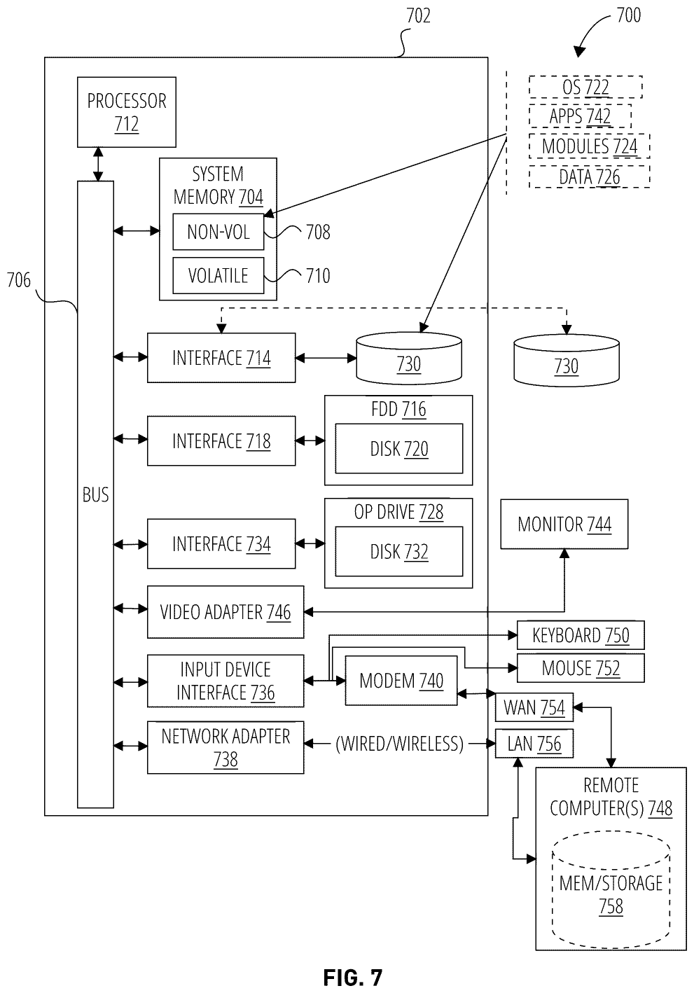

FIG. 7 illustrates an embodiment of an exemplary computer architecture 700 suitable for implementing various embodiments as previously described. In one embodiment, the computer architecture computer architecture 700 may include or be implemented as part of one or more systems or devices discussed herein. For example, the computer architecture 700 includes components that can implement one or more of the automated taxiing system 200, ATC server 116, surveillance system 204, processing circuit 206, memory 208, guidance system 210, avionics equipment 212, and any other computing device described in this application.

As used in this application, the terms “system” and “component” are intended to refer to a computer-related entity, either hardware, a combination of hardware and software, software, or software in execution, examples of which are provided by the exemplary computer architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 700 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 700.

As shown in FIG. 7, the computer architecture 700 includes a processor 712, a system memory 704 and a system bus 706. The processor 712 can be any of various commercially available processors or processor circuits.

The system bus 706 provides an interface for system components including, but not limited to, the system memory 704 to the processor 712. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via slot architecture. Example slot architectures may include without limitation Accelerated Graphics Port (AGP), Card Bus, (Extended) Industry Standard Architecture ((E) ISA), Micro Channel Architecture (MCA), NuBus, Peripheral Component Interconnect (Extended) (PCI (X)), PCI Express, Personal Computer Memory Card International Association (PCMCIA), and the like.

The computer architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile 708 and/or volatile 710. A basic input/output system (BIOS) can be stored in the non-volatile 708.

The computer 702 may include various types of computer-readable storage media in the form of one or more lower speed memory units, including an internal (or external) hard disk drive 730, a magnetic disk drive 716 to read from or write to a removable magnetic disk 720, and an optical disk drive 728 to read from or write to a removable optical disk 732 (e.g., a CD-ROM or DVD). The hard disk drive 730, magnetic disk drive 716 and optical disk drive 728 can be connected to system bus 706 the by an HDD interface 714, and FDD interface 718 and an optical disk drive interface 734, respectively. The HDD interface 714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 708, and volatile 710, including an operating system 722, one or more applications 742, other program modules 724, and program data 726. In one embodiment, the one or more applications 742, other program modules applications 742, and program data 726 can include, for example, the various applications and/or components of the systems discussed herein.

A user can enter commands and information into the computer 702 through one or more wire/wireless input devices, for example, a keyboard 750 and a pointing device, such as a mouse 752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 712 through an input device interface 736 that is coupled to the system bus 706 but can be connected by other interfaces such as a parallel port, IEEE 1394 serial port, a game port, a USB port, an IR interface, and so forth.

A monitor 744 or other type of display device is also connected to the system bus 706 via an interface, such as a video adapter 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory and/or storage device 758 is illustrated. The logical connections depicted include wired/wireless connectivity to a local area network 756 (LAN) and/or larger networks, for example, a wide area network 754 (WAN). Such LAN and WAN networking environments are commonplace in offices and companies, and facilitate enterprise-wide computer networks, such as intranets, all of which may connect to a global communications network, for example, the Internet.

When used in a local area network 756 networking environment, the computer 702 is connected to the local area network 756 through a wire and/or wireless communication network interface or network adapter 738. The network adapter 738 can facilitate wire and/or wireless communications to the local area network 756, which may also include a wireless access point disposed thereon for communicating with the wireless functionality of the network adapter 738.

When used in a wide area network 754 networking environment, the computer 702 can include a modem 740, or is connected to a communications server on the wide area network 754 or has other means for establishing communications over the wide area network 754, such as by way of the Internet. The modem 740, which can be internal or external and a wire and/or wireless device, connects to the system bus 706 via the input device interface 736. In a networked environment, program modules depicted relative to the computer 702, or portions thereof, can be stored in the remote memory and/or storage device 758. It will be appreciated that the network connections shown are exemplary and other means of establishing a communications link between the computers can be used.

The computer 702 is operable to communicate with wire and wireless devices or entities using the IEEE 1402 family of standards, such as wireless devices operatively disposed in wireless communication (e.g., IEEE 1402.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

### ADDITIONAL EXAMPLE EMBODIMENTS

In some embodiments, a method performed by an automated aircraft taxi system is provided for an aircraft taxiing within an airport environment, which comprises obtaining an airport map and representing in real-time a current location of the aircraft on the airport map; obtaining a taxi path trajectory of the aircraft to a destination within the airport environment; computing guidance instructions based on the taxi path trajectory, so that the guidance instructions enable automatically guiding the aircraft within the airport environment according to the taxi path trajectory until reaching the destination; and activating an aircraft protection including a collision-avoidance function that triggers revision of the guidance instructions and/or alerts the pilots of the aircraft when the predicted trajectory of moving objects intersects the taxi path trajectory.

In some embodiments, the method further comprises: detecting moving objects within the airport environment; and identifying a location of the moving objects on the airport map. And the collision-avoidance function disregards an identified object that is moving on a taxiway in the airport environment when a predicted trajectory of the identified object does not intersect the taxi path trajectory according to the location of the identified object and the layout of taxiways on the airport map.

As such, in some embodiments, due to the automated aircraft taxi system as configured above, the automated operation during the taxi phase improves upon existing aircraft systems by providing additional features that allow for the detection of objects positioned on or adjacent to the taxiway of the airport.

According to another embodiment, the collision-avoidance function further triggers revision of the guidance instructions when the taxi path trajectory of the aircraft passes through a detected object or hazard, which includes calculating, based on the location and trajectory of the object or hazard and the current location and the taxi path trajectory of the aircraft, a revised taxi path trajectory to avoid the detected object or hazard. And the method further includes modifying the guidance instructions to thereby alter the taxi path trajectory of the aircraft to the revised trajectory.

According to another embodiment, the airport map identifies locations of objects or hazards already known within the airport environment, and the generated taxi path trajectory avoids collision of the aircraft with the objects or hazards already present on the airport map when obtained by the automated aircraft taxi system.

According to another embodiment, the airport map is provided by an equipment of an airport entity, such as Air Traffic Control equipment or Operations Control Center equipment.

According to another embodiment, the Air Traffic Control equipment provides information about taxi clearances and/or the OCC equipment map provides information about flight dispatch to ease object detection within the airport environment.

According to another embodiment, the automated aircraft taxi system detects hazards and objects within the airport environment by: determining the current location of the aircraft on the airport map and its direction; and based on measurements from surveillance data provided by surveillance aircraft sensors, determining distance and direction of the hazards and objects from the current location of the aircraft.

And the method further comprises determining on the airport map where the hazards and objects should be indicated based on the distance and direction of said hazards and objects with respect to the current location of the aircraft.

According to another embodiment, the method further comprises: detecting border lines of the taxiway ahead of the aircraft using aircraft surveillance sensors; and adjusting the guidance instructions to protect the aircraft from taxiway excursions.

According to another embodiment, the method further comprises: correlating taxiways border lines on the airport map with border lines of the taxiway ahead of the aircraft as captured by the aircraft surveillance sensors; making prediction of the taxiway border lines position in the future as the aircraft is moving; and reducing a field of view of the aircraft surveillance sensors capturing the taxiway border lines ahead of the aircraft according to the prediction.

According to another embodiment, the method further comprises receiving dual inputs to override the guidance instructions, either by both pilots of the aircraft, or by one pilot and an ATC controller, or by one pilot and an OCC dispatcher, and the automated taxi system provides a human-machine interface including an action interface with which the pilots can interact and which has ability to receive instructions from the pilots of the aircraft to request that the protection order be overridden, and the automated taxi system has the ability to receive digital messages from Air Traffic Control equipment and/or Operations Control Center equipment which provide confirmation that the guidance instructions can be overridden.

In some other embodiments, a computer program product comprising executable instructions is provided, which when executed by a processing circuit of a computing device causes the computing device to execute the method above according to any one of its embodiments. It is further proposed herein a non-transitory computer-readable storage medium having executable instructions stored thereon, which when read from the non-transitory computer-readable storage medium and executed by a processing circuit of a computing device causes the computing device to execute the method above according to any one of its embodiments.

It is further proposed herein an automated aircraft taxi system for an aircraft taxiing within an airport environment, which comprises electronic circuitry configured to implement: obtaining an airport map and representing in real-time a current location of the aircraft on the airport map; obtaining a taxi path trajectory of the aircraft to a destination within the airport environment; computing guidance instructions based on the taxi path trajectory, so that the guidance instructions enable automatically guiding the aircraft within the airport environment according to the taxi path trajectory until reaching the destination; and activating an aircraft protection including a collision-avoidance function that triggers revision of the guidance instructions and/or alerts the pilots of the aircraft when the predicted trajectory of moving objects intersects the taxi path trajectory of the aircraft.

In some embodiments, the electronic circuitry is configured to further implement detecting moving objects within the airport environment; and identifying a location of the moving objects on the airport map.

The electronic circuitry is further configured such that the collision-avoidance function disregards an identified object that is moving on a taxiway in the airport environment when a predicted trajectory of the identified object does not intersect the taxi path trajectory of the aircraft according to the location of the identified object and the layout of taxiways on the airport map.

In some other embodiments, an aircraft is provided that includes such an automated aircraft taxi system.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. An automated taxiing system for an aircraft comprising:
a surveillance system comprising one or more sensors to capture surveillance data on a taxiway of an airport;
an aircraft guidance system configured to alter a trajectory of the aircraft during a taxiing phase of the aircraft; and
a processing circuit in communication with the surveillance system and coupled to a memory having executable instructions stored thereon, which when executed by the processing circuit cause the processing circuit configured to:
receive the surveillance data and determine, based on an analysis thereof, whether an object or hazard is present on, or adjacent to, the taxiway;
in response to determining that the object or hazard is present on, or adjacent to, the taxiway, indicate a location of the object or hazard on a geographic map of the airport and save the location of the object or hazard in the memory;
predict a trajectory of the object or hazard in relation to a location and the trajectory of the aircraft;
calculate, based on the location and trajectory of the object or hazard and the location and trajectory of the aircraft, a guidance order for the aircraft including a revised trajectory to avoid the object or hazard; and
send the guidance order to the aircraft guidance system of the aircraft to thereby alter the trajectory of the aircraft to the revised trajectory.

2. The automated taxiing system of claim 1, wherein the one or more sensors comprises one or more of:
one or more cameras;
a lidar device;
a radar device;
a microwave sensor; and
an infrared sensor.

3. The automated taxiing system of claim 1, wherein the geographic map of the airport comprises taxiway segments and service road locations;
wherein determining that the object or hazard is present on the taxiway includes the processing circuit being configured to determine whether the object or hazard is located on a taxiway segment or service road;
wherein determining that the object or hazard is adjacent to the taxiway includes the processing circuit being configured to determine whether the object or hazard is located within a predetermined distance of the taxiway segment or service road; and
wherein predicting the trajectory of the object or hazard includes the processing circuit configured to forecast a movement of the object or hazard on the taxiway segment or service road.

4. The automated taxiing system of claim 1, wherein the object or hazard is a stationary object;
wherein the processing circuit is configured to determine that the object or hazard is the stationary object based on the surveillance data and the location of the object or hazard on the geographic map;
wherein, in response to the processing circuit determining that the object or hazard is a stationary object, the processing circuit is configured to predict that the object or hazard will remain stationary in relation to the aircraft.

5. The automated taxiing system of claim 1, wherein the surveillance system is configured to detect borderlines of the taxiway;
wherein the processing circuit is configured to correlate the borderlines to mapped borderlines of the taxiway on the geographic map and predict a further location of the taxiway borderlines as the aircraft continues moving, the further location of the taxiway borderlines being based on the mapped borderlines of the taxiway; and
wherein predicting the trajectory of the object or hazard and calculating the guidance order are performed based on the borderlines of the taxiway correlated to the mapped borderlines of the taxiway on the geographic map.

6. The automated taxiing system of claim 5, wherein a field of view of the one or more sensors is adjusted by the processing circuit being configured to no longer capture data on the borderlines of the taxiway.

7. The automated taxiing system of claim 5, wherein predicting the trajectory of the object or hazard includes the processing circuit being configured to predict the trajectory of the object or hazard based on the geographic map of the taxiway.

8. The automated taxiing system of claim 1, wherein altering the trajectory of the aircraft to the revised trajectory includes the aircraft guidance system being configured to move the aircraft towards a runway; and
wherein a runway incursion protection system prevents the aircraft from moving onto the runway by instructing the aircraft guidance system to stop the aircraft before the aircraft enters the runway.

9. The automated taxiing system of claim 8, wherein the processing circuit is configured to receive a clearance to move the aircraft onto the runway from a pilot of the aircraft in response to an air traffic control (ATC) server communicating the clearance to the pilot.

10. The automated taxiing system of claim 8, wherein the processing circuit is configured to receive an input from a pilot and co-pilot of the aircraft or from the pilot and an airline operational center (OCC), the input overriding the runway incursion protection system and allowing the aircraft to move onto the runway.

11. The automated taxiing system of claim 1, wherein the processing circuit is configured to access the geographic map of the airport, wherein the geographic map includes a predefined object or hazard present on the taxiway, wherein calculating the guidance order including the revised trajectory includes calculating the guidance order and revised trajectory to avoid the predefined object or hazard present on the taxiway.

12. The automated taxiing system of claim 11, wherein accessing the geographic map includes the processing circuit being configured to communicate with an airport entity to access the geographic map, wherein the airport entity includes an Air Traffic Control (ATC) computing device or an Operations Control Center (OCC) computing device.

13. The automated taxiing system of claim 1, wherein the processing circuit is further configured to cancel the guidance order and thereby end alteration of the trajectory of the aircraft in response to receiving dual inputs to override the guidance order, wherein the dual inputs include inputs from any of:
both pilots of the aircraft;
one pilot and an air traffic control (ATC) system; or
one pilot and an operations control center (OCC) system;
wherein the automated taxiing system further comprises a user interface with which pilots can interact and is configured to receive instructions from the pilots of the aircraft to request that the guidance order be overridden; and
wherein the automated taxiing system is configured to receive electronic messages from the ATC system and/or the OCC system which provide confirmation that the guidance order can be overridden.

14. A method for taxiing an aircraft comprising:
capturing, using a surveillance system comprising one or more sensors, surveillance data on a taxiway of an airport;
receiving, at a processing circuit, the surveillance data and determining, based on an thereof, whether an object or hazard is present on, or adjacent to, the taxiway;
in response to determining that the object or hazard is present on, or adjacent to, the taxiway, indicating, by the processing circuit, a location of the object or hazard on a geographical map of the airport and saving the location of the object or hazard in a memory coupled to the processing circuit;
calculating, by the processing circuit, a trajectory of the object or hazard in relation to a location and trajectory of the aircraft;
calculating, by the processing circuit, based on the location and trajectory of the object or hazard and the location and trajectory of the aircraft, a guidance order for the aircraft including a revised trajectory to avoid the object or hazard;
sending the guidance order to an aircraft guidance system of the aircraft; and
altering, by the aircraft guidance system, the trajectory of the aircraft to the revised trajectory.

15. The method of claim 14, wherein the geographic map of the airport comprises taxiway segments and service road locations;
wherein determining that the object or hazard is present on the taxiway includes determining whether the object or hazard is located on a taxiway segment or service road;
wherein determining that the object or hazard is adjacent to the taxiway includes determining whether the object or hazard is located within a predetermined distance of the taxiway segment or service road; and
wherein predicting the trajectory of the object or hazard forecasting a movement of the object or hazard on the taxiway segment or service road.

16. The method of claim 14, wherein the object or hazard is a stationary object;
wherein the method further includes determining that the object or hazard is the stationary object based on the surveillance data and the location of the object or hazard on the geographic map;
wherein, in response to determining that the object or hazard is a stationary object, the method further includes predicting that the object or hazard will remain stationary in relation to the aircraft.

17. The method of claim 14, wherein the method further includes using a surveillance system comprising one or more sensors to detect borderlines of the taxiway;
wherein the method further includes correlating the borderlines to mapped borderlines of the taxiway on the geographic map and predicting a further location of the taxiway borderlines as the aircraft continues moving, the further location of the taxiway borderlines being based on the mapped borderlines of the taxiway; and
wherein predicting the trajectory of the object or hazard and calculating the guidance order are performed based on the borderlines of the taxiway correlated to the mapped borderlines of the taxiway on the geographic map.

18. The method of claim 17, wherein predicting the trajectory of the object or hazard includes predicting the trajectory of the object or hazard based on the geographic map of the taxiway.

19. The method of claim 14, wherein altering the trajectory of the aircraft to the revised trajectory includes moving the aircraft towards a runway; and
wherein a runway incursion protection system prevents the aircraft from moving onto the runway by instructing the aircraft guidance system to stop the aircraft before the aircraft enters the runway.

20. A non-transitory computer readable storage medium having executable instructions stored thereon, which, when executed by a processing circuit of an aircraft system of an aircraft, causes the aircraft system to:
receive surveillance data from a surveillance system comprising one or more sensors to capture the surveillance data on a taxiway of an airport;
determine, based on an analysis of the surveillance data, whether an object or hazard is present on, or adjacent to, the taxiway;
in response to determining that the object or hazard is present on, or adjacent to, the taxiway, indicate a location of the object or hazard on a geographic map of the airport and save the location of the object or hazard in a memory;
predict a trajectory of the object or hazard in relation to a location and the trajectory of the aircraft;
calculate, based on the location and trajectory of the object or hazard and the location and trajectory of the aircraft, a guidance order for the aircraft including a revised trajectory to avoid the object or hazard; and
send the guidance order to the aircraft guidance system of the aircraft to thereby alter the trajectory of the aircraft to the revised trajectory.
